(19) United States
(12) Patent Application Publication
(10) Pub. No.: US 2011/0213564 A1
(43) Pub. Date: Sep. 1, 2011

(54) METHOD AND APPARATUS FOR CODE VERIFIED TESTING

(76) Inventor: Tom L. Henke, Shorewood, MN (US)

(21) Appl. No.: 12/714,355

(22) Filed: Feb. 26, 2010

(51) Int. Cl. G06F 15/00; G06F 17/00

(52) U.S. Cl. 702/23; 702/127

(57) ABSTRACT

This document discusses, among other things, a method for verifying a result of a test. The method includes providing a plurality of codes that are indicative of a first result of a test. A first test is then performed on a material. A first code of the plurality of codes is output when the first test produces the first result.

### BACKGROUND

At-home testing devices provide the ability to conduct a test in the comfort of one's own home and can provide instant results. Many at-home testing devices exist including medical based tests, water quality tests, and hazardous chemical tests (e.g., lead). One valuable and growing at-home testing area is at-home medical tests. At-home medical tests are typically provided over-the-counter, however, these tests can also be provided via prescription. These at-home medical tests include diagnostic strip tests and electronic tests. Many of these medical tests can provide instant results. Numerous at-home medical tests exist today and many continue to be developed including tests for pregnancy, influenza, urinary tract infection, and cholesterol, among others.

As mentioned above, at-home medical tests can include diagnostic strip tests. Diagnostic strip tests can determine the presence (or absence) of a chemical (also referred to herein as the “chemical of interest”) within a fluid sample obtained from a patient. The chemical of interest can be identified with an assay. Typically, when the chemical of interest is present, a visible indication is caused on the test strip. The visible indication indicates the presence of the chemical of interest to a user. The visible indication can include a symbol (e.g., line) or a shade of a color and can represent both the presence (or absence of the chemical of interest) and the relative quantity of a chemical in the fluid sample.

At-home medical test can also include electronic tests. In some examples, an electronic testing device can analyze a fluid sample directly, such as through placement of a fluid sample on the electronic device or through extraction of a fluid sample from a patient with the use of an electronically actuated needle. In other examples, the electronic testing device operates in conjunction with a test strip, such that the electronic testing device “reads” the visible indication provided by the test strip. In any case, the electronic testing device obtains the results to the test and provides the results to a user. The electronic testing device can provide the results directly to a user via, for example, display on the electronic testing device, an audible output, or via other means. In addition, the electronic testing device can provide the results to another device (e.g., a personal computer) for further processing, storage, or for indirect presentation to the user.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of method for verifying a result of a test.

FIG. 2 illustrates generally an example of two possible results for a test strip.

FIG. 3 illustrates generally an example of an electronic testing device.

FIG. 4 illustrates generally an example of a method for diagnosing a patient with test verification.

FIG. 5 illustrates generally an example of a computer for implementing methods described herein.

### DETAILED DESCRIPTION

At-home testing devices provide many benefits, most notably, the convenience of immediate access and possibly immediate results. At-home medical tests also provide the advantage of being substantially cheaper and less time consuming than a visit to a healthcare practitioner. Visits to one's healthcare practitioner can take several hours and cost $70-$200 dollars or more for routine checkups. For example, a visit to be checked for strep throat can cost upwards of $150 dollars for the consultation and test. The actual cost of a strep test, however, can be as low as $2 and the treatment for strep can cost as low as $4. Moreover, strep tests are negative about 88% of the time. Accordingly, it can take over an hour and cost around $150 dollars to determine (in the vast majority of cases) that a patient does not have strep throat. Additionally, even when a patient tests positive for strep throat, the cost to make this determination is substantially more than the actual cost of the treatment and testing.

The present inventor has recognized, among other things, a method for at-home testing that enables a third party to verify the results of the at-home test. In certain examples, a user can purchase an at-home medical test to, for example, determine whether a patient has strep throat. The user can provide the results of the at-home test to a healthcare practitioner. A verification system can be used to verify the results of the at-home test for the healthcare practitioner. Accordingly, the healthcare practitioner can, for example, comfortably rely on the at-home test results to diagnose the patient. Thus, the patient can receive diagnosis and treatment for without having to physically visit a healthcare practitioner.

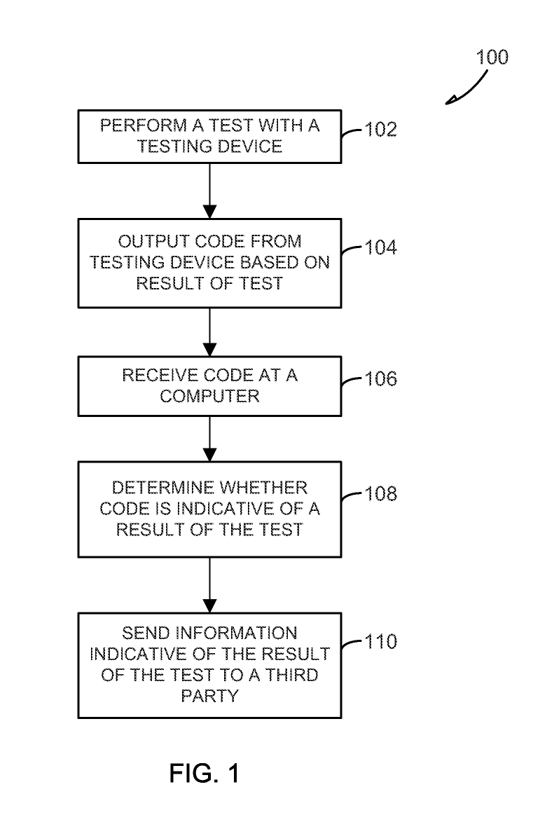

FIG. 1 illustrates generally an example of a method 100 for testing of a material and verifying the results of the test. At 102, a test is performed on a material with the use of a testing device. In general there is no limit to the type of test that can be performed, the testing device, or the subject (e.g., material) of the test. For example, the test can include a medical test conducted to determine whether a patient has strep throat. In another example, the test can include a medical test to determine the sugar level in the blood of a patient. In yet another example, the test can include an agricultural test to determine whether a particular plant is infected with a disease. In still another example, the test can include a water quality test to determine the presence of one or more chemicals in a water supply.

In other examples, the test can include a myriad of other tests already developed or to-be developed including medical, agricultural, forensic, human/animal drug testing, food safety, and others. Likewise, the material can include any physical substance including solid, liquid, or gaseous materials. In addition, the material can include electrical or mechanical devices, machines, or other apparatus.

In an example, the test can include a chemical property based test. In an example, a chemical based test can include tests that analyze the chemical properties of a material to, for example, determine the presence or absence of a particular chemical. Many at-home medical tests are chemical based tests where a fluid sample is obtained and analyzed in an assay to determine whether the fluid sample contains the chemical of interest. In another example, the chemical based test can determine the quantity or concentration (in addition to the presence) of a chemical in a fluid sample.

In another example, the test can include a physical property based test. In an example, a physical property based test can include a test that analyzes a physical property of the material. Physical property based tests can include test that determine the transparency, a mass, a density, or other physical property of a material or fluid.

In yet another example, the test can include a knowledge based test such as an exam. Knowledge based tests can include a school exam (e.g., college), an exam for obtaining a license, or other exam. In still another example, the test can include an electrical functionality test including the testing of an electrical device for certain functionality.

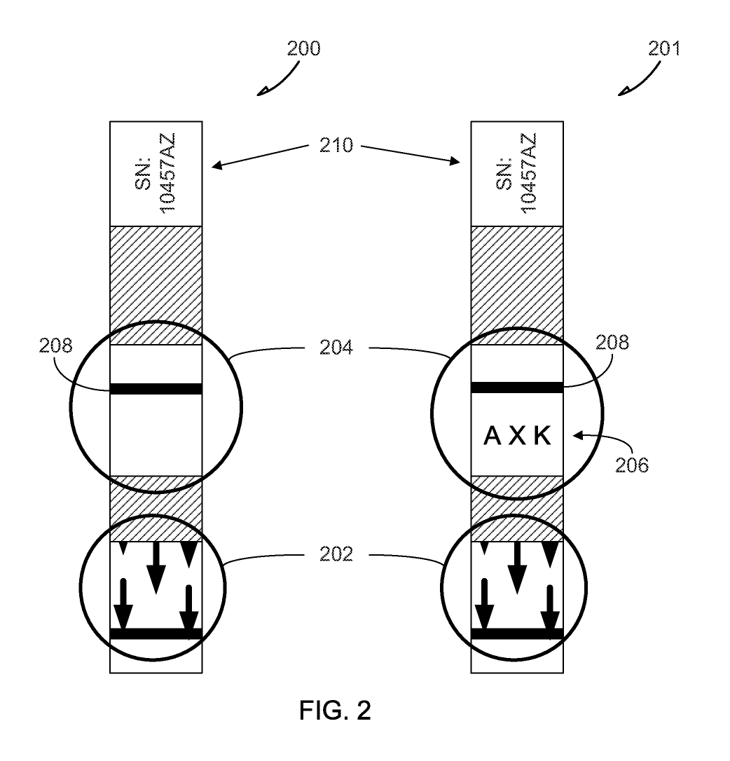

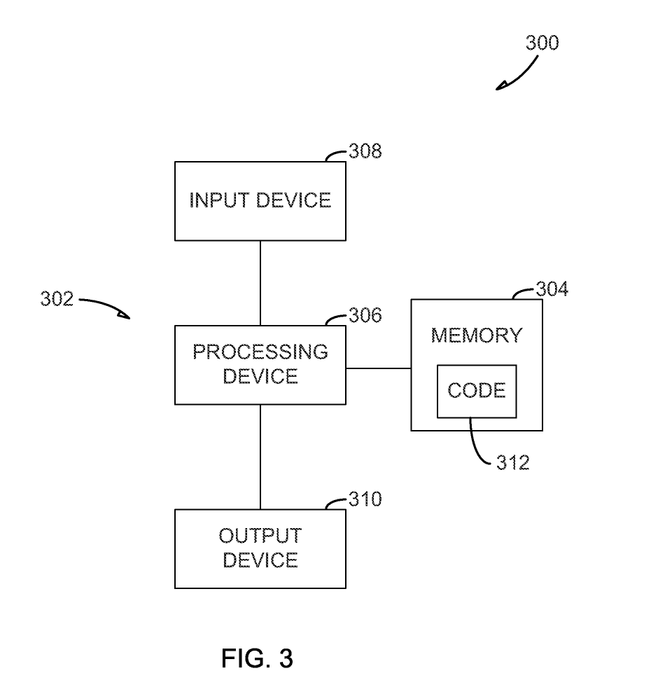

In an example, the testing device can include a test strip for performing an assay on a fluid sample. More detail regarding a test strip testing device is provided with respect to FIG. 2. In another example, the testing device can include an electronic testing device. More detail regarding an electronic testing device is provided with respect to FIG. 3.

At 104, the testing device outputs a code based on a result of the test. In an example, the testing device outputs the code by displaying the code on a display device. In certain examples, the display device can be physically connected to (e.g., integral with) the display device. In other examples, the display device can be remote from and communicatively coupled to (e.g., wirelessly) the testing device. In an example, the testing device outputs the code by changing one or more colors on selected portions of a test strip to form one or more symbols for the code. The placement of the color change can be selected such that the one or more symbols are formed via color contrast with a surrounding area.

In an example, the code output by the testing device can include a plurality of numbers, letters, characters, or other symbols in a defined order. In an example, the code can include symbols that are capable of being input into an input field of a software program executing on a computer. In an example, the number and variety of possible symbols used for a code comprises a sufficient number of symbols such that the code is difficult to guess. In an example, the code comprises at least 2 numbers or letters. Example codes can include 5584839, 02S36EP, and #M % H*Z1.

As mentioned above, the code is output based on the results of the test. In an example, the code is selectively output such that when a test by the testing device produces a first result the code is output, when the test by the testing device produces a second result, however, the code is not output. Accordingly, the user is provided the code when the test produces the first result, but the user is not provided the code when the test produces the second result. For example, a test strip that is configured to test for the presence of a chemical of interest has possible results that include: 1) a first result indicating that the chemical of interest is present in a sample, and 2) a second result indicating that the chemical of interest is not present in the sample. Accordingly, when the code is selectively output, the code is output when the chemical of interest is present (first result) and the code is not output when the chemical of interest is not present (second result). In another example, a different code is output depending on which of the results occurs. For example, the first code is output when the test produces a first result and a second code is output when the test produces a second result.

In an example, the code output by the testing device when a first result is produced by a test of the testing device is indicative of the first result. That is, the code can be used to determine that the test produced the first result. As an example, prior to performing the test the code is defined as indicating the first result. Accordingly, an entity that knows that the code is defined as indicating the first result, can determine that the test produced the first result based solely on the code. In an example, a code that is defined to indicate a first result is output when the test produces the first result, but not when the test produces other results.

In an example, there are a plurality of codes that are indicative of the same result. In an example, prior to performing the test, each of the plurality of codes can be defined as indicating the first result. Accordingly, the testing device can be configured to output any of the plurality of codes as an indication of the first result, and any of the plurality of codes can be used to determine that the test produced the first result.

Advantageously, the code can be used by a third party that did not perform the test to verify that the test produced the first result. For example, a user of the testing device, after performing the test and receiving the code output by the testing device, can provide the code to a third party. The third party knowing that the code indicates the first result can then determine (verify) that the test performed by the user did in fact produce the first result. In an example, in order to ensure that the user did not obtain the code from another source (or guess the code), the code is selected such that a number and variety of different symbols can be used for the code. Additionally, the number of times a code is re-used can be limited to ensure that the user is not simply using a code from another testing device. Furthermore, the information regarding which code or codes are indications of a particular result can be kept secret to be used for determination (verification) of the results of tests. Accordingly, when the third party can be assured that the user would not likely possess the code other than receiving the code from the testing device, the third party can determine (verify) that the user did perform a test that produced the first result.

In an example, each of a plurality of testing devices is configured to output one of the plurality of codes to indicate the first result. In an example, each of a plurality of testing devices is configured to output a different code(s) of the plurality of codes to indicate the first result. Thus, a user cannot easily guess what the code of a particular testing device is simply by knowing the code of another testing device. In an example, the plurality of codes comprise a sufficient number of codes such that a code for a particular testing device is difficult to guess. The number of different codes used can depend on the application and the level of security required in the verification. For example, a suitable number of codes for an application where only 100 testing devices are distributed may be 25. However, another application where over 1000 testing devices are used can use 250 different codes. In certain examples where there are more tests used than the available codes, some or all codes may be re-used. However, the number of codes selected can be based on the number of tests used, such that codes are not overly re-used. Additionally, the time period between re-use of codes can be taken into account in the number of codes used. In yet another example, each testing device has one or more unique codes. That is, a code is used for a single testing device. Thus, once a code is known and used, the code cannot be re-used as fake verification of another test. In examples where testing devices can perform multiple tests, each test performed by the testing device can have a unique code. In still another example, each testing device can have a plurality of codes associated therewith and each of the plurality of codes is not re-used by another testing device (e.g., each code is associated with a single testing device). The testing device, therefore, can output one of the plurality of codes for each result in which a code is to be output. When the result of the test does not correspond to a code being output, the next code to be output can be saved to use for the next test, if necessary. Accordingly, each code can be unique in that the code is used for a single result, but each test may or may not correspond directly to each unique code.

In an example, a second plurality of codes are indicative of a second result. Thus, if a test performed by a testing device indicates a first result, one of the (first) plurality of codes is output as mentioned above. If a test performed by the testing device indicates a second result, one of the second plurality of codes is output. In other examples, the test can have more than two possible results and each of the possible results can have a plurality of codes associated therewith.

In an example, the code output by the testing device can be combined with a second code to form a composite code. In an example, the second code can be provided to a user regardless of whether the test has be taken and can be independent of the results of the test. The (first) code, however, is output to the user after the test based on the results of the test. More detail regarding a composite code is provided with respect to FIG. 2.

In an example, a sample of a material can be sent (e.g., via mail) to a lab and a test can be performed at the lab. The lab can then return one or more codes indicative of results of the test.

At 106, a code is received in order to determine the results of a test. In an example, a computer receives the code via a user inputting the code in an input field of a program executing on the computer. The code can be input into the computer via a user entering the code with a keyboard or other input device communicatively coupled to the computer. In an example, the (first) code can be input along with a second code when a composite code is used as mentioned above and discussed in detail below. Here, the (first) code can be input into a first input field and a second code can be input into a second field.

Once the computer receives the code, at 108, the computer can determine whether the code is one of a plurality of codes indicative of a result of the test. As mentioned above, a plurality of different codes can be defined as indicative of the same result. In an example, to determine whether the code received is one of the plurality of codes indicative of a result, the computer can compare the code to each of the plurality of codes. In another example, the computer can use an algorithm to determine if the code matches one of the plurality of codes. In examples where the code is input along with a second code to form a composite code, the computer can compare each code to corresponding lists of codes, or can combine the codes to form the composite code and compare the composite code to a list composite codes.

If the code is determined to be indicative of a result of a test, at 110, the result of the test is sent to a third party. As used herein, “third party” refers to a entity (e.g., human or computer) that does not have actual knowledge of the test results prior to receiving the results. For example, the third party can include a healthcare practitioner at a clinic that receives the results of a test performed by a patient in the patient's home. In another example, the third party can include a law enforcement agency that receives the results of a drug test performed by a user. In another example, the computer outputs the code by sending the result of the test to another computer (e.g., over a network). In another example, the third party can include a computer operated by a third party (e.g., a healthcare practitioner) for review of the result of the test.

In an example, when the code matches another code, the computer determines which result the matched code corresponds to. The result that corresponds to the matched code is output from the computer. For example, a computer and/or a particular test may have four different possible results. The computer determines which possible result the matched code corresponds to and outputs that result.

In an example, the computer can display the result on a display device for the user. In an example, the testing device provides the user with the code but does not provide the user with the actual result of the test. Accordingly, in order to receive the result of the test, the user inputs the code into the computer and the computer displays the result of the test for the user. In an example, when the computer determines that the code does not match a code indicating a result of the test, the computer outputs that the code is an invalid code.

FIG. 2 illustrates examples of test strips 200, 201 for outputting a code for test result verification. Test strips 200 and 201 illustrate the alternative result scenarios for an example test strip after performance of a test. Test strips 200, 201 include a sample zone 202, at least one result zone 204. In an example, test strips 200, 201 comprises are elongated rectangular component. In certain examples, test strips 200, 201 can be composed of paper, nitrocellulose, or other porous inert materials.

Sample zone 202 comprises an area on the test strips 200, 201 configured to receive a fluid sample of a material through contact with the fluid sample. Sample zone 202 can receive a fluid sample of a material in numerous ways including dipping the sample zone 202 into the fluid sample, placing the sample zone 202 in a stream of a fluid sample, or placing one or more droplets of a fluid sample on the sample zone 202.

In an example, test strip 202 draws the fluid sample from the sample zone 202, along the test strips 200, 201, and toward the result zone 204 through capillary action. In an example, the result zone 204 comprises an area with one or more chemical compounds configured to react with a chemical of interest in a fluid sample. The chemical of interest comprises a chemical in which a test is directed to identify. In an example, the result zone 204 comprises a layer of a chemical compound printed on the test strips 200, 201. As the fluid sample is drawn past the result zone 202, the chemical compound of the result zone 202 is configured to chemically react with the chemical of interest and cause an identifiable change. In an example, the identifiable change includes a visibly identifiable change such as a color change on the test strips 200, 201. In an example, quantitative results can be ascertained based on the magnitude of the identifiable change of the result zone 202. For example, a color change induced by the chemical reaction in the result zone 202 can be more intense (e.g., darker) when the chemical of interest is of a higher quantity in the fluid sample. In another example, the identifiable change of the result zone 202 can include changing to different colors depending on which result is achieved. For example, a first result can cause the result zone 202 to change to a pink color, and a second result can cause the result zone 202 to change to a green color. In an example, the test strips 200, 201 can include multiple result zones 204 to, for example, repeat a test for verification, perform an additional test, or for quantitative determinations.

Test strip 200 can test by, for example, immunodiagnostic, enzymatic, lateral flow immunochromotography, or chemistry type reactions. Examples of applications for test strip 200 include single tests (e.g., pregnancy) or multiple simultaneous tests (e.g., testing for the presence of multiple drugs). The result zone 204 can be used to identify the presence or absence of the chemical of interest or can be used to provide quantitative information regarding the chemical of interest.

In an example, the code output by the test strips 200, 201 is referred to herein as a “result code” 206. For example, the result code is visible in result zone 204 of test strip 201. In an example, test strips 200, 201 are configured to output the result code 206 based on a result of the chemical reaction between the fluid sample and one or more chemicals on the test strips 200, 201.

The result code 206 is output by being visibly displayed directly on the test strips 200. For example, a chemical compound can be selectively positioned such that a color change caused by the reaction between the chemical compound and the chemical of interest forms one or more symbols (e.g., letters, numbers, etc.) to form the code. In an example, prior to output of the result code 206 the result zone 204 is of a uniform color. When the result code 206 is output, selected portions (in the shape of symbols) of the result zone 204 change color to contrast with the surrounding. Thus, the symbols of the result code 206 become visible.

In another example, a mask can be oriented over the result zone 202 to selectively block and view portions of the color change, such that the viewable portions of the color change form one or more symbols. In this way, the code can be invisible prior to the assay by the test strip 200, and based on the results of the assay, the code either remains invisible or is changed to visible form by displaying the code for view by a user. In an example, when a chemical of interest is not present within a fluid sample, the result code 206 remains invisible as shown in test strip 200. When the chemical of interest is present within the fluid sample, the result code 206 becomes visible as shown in test strip 201. Accordingly, test strip 200 shows a result of a test where the chemical of interest was not present in the fluid sample. Likewise, test strip 201 shows a result of a test where a chemical of interest was present in the fluid sample. In other examples, the result code can remain invisible when the chemical of interest is below a certain threshold quantity within the fluid sample. When the chemical of interest is above the threshold quantity the result code becomes visible.

In other examples, the test strip 200, 201, can be configured to output different result codes 206 depending on the result of the test. For example, when the chemical of interest is not present in a fluid sample, a chemical reaction on the test strip 200, 201 can cause a first code (e.g., PJE) to be output in the result zone 202. When, the chemical of interest is present, however, a chemical reaction on the test strip 200, 201 can cause a second code (e.g., AXK) to be output in the result zone 202.

In an example, an assay on the test strip can be used for the chemical reaction between the chemicals on the test strips 200, 201 and the fluid sample. The chemical reactions of the assay, in turn, can cause the visible color change. The placement of the chemicals that react to cause the color change can form.

The test strips 200, 201 can also include a reaction verification line 208. Here, the reaction verification line 208 is illustrated as a portion of the result zone 204. The reaction verification line 208 is used to illustrate to a user that the test has been performed. Prior to the test being performed, the reaction verification line 208 is not visible. Once, however, the test is performed by placing the fluid sample on the test and causing a chemical reaction on the test strip 200, 201, the reaction verification line 208 becomes visible to indicate that the chemical reaction has occurred on the test strip. In an example, the reaction verification line 208 may become visible due to a chemical reacting with any fluid sample placed on the sample zone 202 of test strips 200, 201. The reaction verification line 208, therefore, illustrates to a user that the test has been performed regardless of the outcome of the assay performed.

In an example, the test strips 200, 201 can include a serial number 210. Due to, for example, size restrictions on the test strip 200, the result code 208 output by the result zone 204 of the test strip 200 may not comprise a sufficient length to ensure the result code 208 is difficult to guess in certain situations. Accordingly, in some embodiments, the test strips 200, 201 include a serial number 210 associated therewith in conjunction with the result code 208. The serial number 210 can comprise a plurality of symbols that can be perceived regardless of the result of the test performed with the test strips 200, 201. In an example, the serial number can be perceived by the user as soon as the user has access to the test strip. For example, the serial number 210 can be printed on a surface of the test strips 200, 201 during manufacture of the test strips 200, 201. In another example, the serial number 210 can be printed on documentation included with the test strips 200, 201.

The serial number 210 can then be used with the result code 206 to form a composite code as mentioned above. In an example, the serial number 210 comprises a sufficient number of characters such that the combination of the serial number 210 and the result code 206 cannot be easily guessed. As an example, the serial number 210 can comprise at least 5 characters. In an example, the result code 206 can comprise three characters. The serial number 210 and the result code 206 can therefore be input into a verification system as described at 104-108 of method 100.

Accordingly, depending on the result of the test, the result code 206 may not be output or a different result code 206 may be output, but the serial number 210 does not change and is perceivable regardless of the result of the test. The example serial number 210 for the test strips 200, 201 is 10457AZ. The example result code 206 can shown in FIG. 2 is AXK. Thus, the composite code of serial number 210 and result code 206 would be 10457AZ-AXK. To reiterate, test strips 200, 201 represent the same test strip showing two possible results of a test with the test strip. Since test strips 200, 201 represent the same test strip, test strips 200, 201 have the same serial number 210.

Utilizing a composite code composed of multiple individual codes enables the composite code to comprise a relatively long number of symbols, but does not require the testing device to actually output all the symbols of the composite code. Instead, the testing device can output less than all of the symbols (the symbols of the first code) based on the result of the test. Utilizing a composite code can be particularly advantageous when, for example, the testing strips 200, 201 do not have adequate space (or it may not be cost effective) for a long code to be output via color change as described above.

In an example, each of a plurality of test strips 200, 201 have a serial number 210 associated therewith and a result code associated therewith. A plurality of different serial numbers 210 are used such that it is difficult to guess a serial number 210 for a given test strip 200, 201. In addition, each test strip 200, 201 has a result code 206 configured to become visible or remain invisible based on a result of a test performed by the test strip 200, 201. A plurality of result codes 206 are also used such that the result code 206 associated with a particular serial number 210 cannot be easily guessed.

FIG. 3 illustrates an example of an electronic testing device 300 configured to output a code based on the results of a test for verification of the results by a third party. In an example, electronic testing device 300 includes an electronic circuit 302 comprising a memory 304 and processing device 306. Electronic testing device 300 also includes an input device 308 for results of a test on a material. Electronic testing device 300 also includes an output device 310 for outputting a code 312 based on the results of a test.

The input device 308 of electronic testing device 300 obtains information regarding a test performed on a material. In an example, the input device 308 can include circuitry configured to “read” an identifiable change caused by a test strip (e.g., test strip 200, 201). The identifiable change can be a change visible to a human eye (e.g., a color change) or invisible to a human eye (e.g., an infrared change). For example, the result zone 202 can form one or more stripes of a bar code based on a result of the test. This bar code can then be read by the input device 308 of electronic testing device 300. In another example, the identifiable change caused by the chemical reaction is invisible to a human, but is detectable (via e.g., infrared) by the input device 308. In yet another example, the input device 308 reads the intensity of a color change of the result zone 202 to determine a quantity or presence of the chemical of interest. In still another example, the input device 308 reads the color (e.g., pink vs. green) of the result zone 202 of a test strip 200, 201.

In other examples, the input device 308 can include a circuitry configured to obtain a reading directly from a material. For example, the electronic testing device 300 can analyze a material directly, such as through placement of a sample of the material on the electronic testing device 300, the electronic testing device 300 transmitting a signal (e.g., light) towards the material, or through extraction of a fluid sample from a patient with the use of an electronically actuated needle. In any case, the electronic testing device 300 obtains information regarding a test performed on a material.

In an example, the processing device 306 receives the information from the input device 308 determines a result for the test based on the information received. In an example, the memory 304 can contain instructions (e.g., software, firmware) that cause the processing device 306 to perform actions to determine a result based on the information received from the input device 308. In an example, the memory 304 can include one or more codes 312 that can be output from the electronic testing device 300 based on a result of the test.

For example, the input device 308 can read a result zone 202 of a test strip 200, 201 and provide information to the processing device 306. The input device 308 can, for example, determine which color the result zone 202 has changed to. Information indicative of the color of the result zone 202 can then be provided to the processing device 308 and the processing device can determine which code to output (or whether or not to output a code) based on the information indicative of the color of the result zone 202. For example, when the result zone 202 is pink, the electronic testing device 300 can output a first code, and when the result zone 202 is green, the electronic testing device 300 can output a second code.

In an example, the processing device 306 can include a general purpose processor (e.g., an Intel Pentium Processor), a microcontroller, a field programmable gate array (FPGA), or other processing device.

In an example, the output device 308 can comprise a display configured to visibly display the code 312. In another example, the output device 308 can include a transmission device for transmitting the code 312 to another electronic device (e.g., a personal computer). In yet another example, the output device 308 can include a speaker for providing audible tones indicative of the code 312.

Based on the results of the test, the electronic testing device 300 outputs a code 312 as described in more detail with respect to FIG. 1. In an example, the testing device 300 outputs the code 312 when the result of the test is a first result and, does not output the code when the result of the test is a second result. In another example, the testing device 300 outputs a first code when the result of the test is a first result and a second code when the result of the test is a second result.

The electronic testing device 300 can provide the results directly to a user via, for example, display on the electronic testing device, an audible output, or via other means. In addition, the electronic testing device can provide the results to another device (e.g., a personal computer) for further processing, storage, or for indirect presentation to the user.

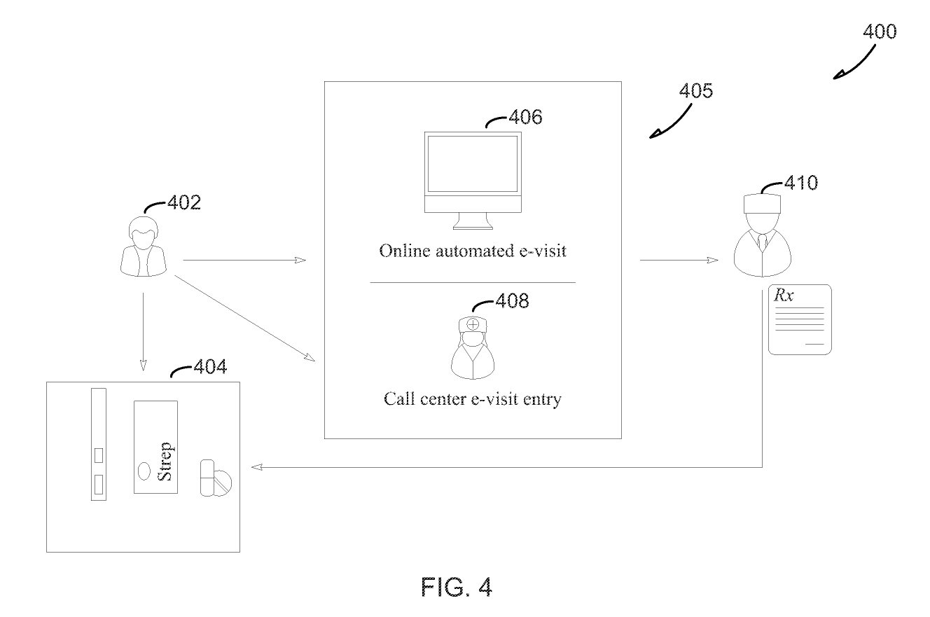

FIG. 4 illustrates an example of a method 400 for a user 402 using method 100 to perform an at-home medical test and use the test results to obtain diagnosis. The user 402 purchases or otherwise obtains a testing device from a commercial retailer 404 (e.g., a pharmacy). The user 402 then performs the medical test by, for example, placing a fluid sample on a test strip and inserting the test strip into an electronic testing device. Depending on the results of the test, the test device can output a code to the user 402.

The user 402 takes the code an inputs the code into the verification system 405 for initiation of an “e-visit”. In an example, the verification system 404 includes a call-center based verification system 406 and an online verification system 408. For the call-center verification system 406, the user can input the code via the keypad on a phone or via verbally speaking the code. The call-center verification system 406 can then receive the code by receiving the keypad inputs or converting the spoken code into a digital code. The call-center verification system 406 can then determine whether the code is indicative of a result of the test by comparing the code to a list of codes that are defined as indicative of results of a test. If the code is not indicative of a result, the call-center verification system 406 can respond that the code is invalid. If the code is indicative of a result, the call-center verification system 406 can let the user 402 know the results of the test and send an indication of the results of the test to a healthcare practitioner 410. In an example, the call-center verification system 408 can be all or partially computer automated.

Similarly, for the online verification system 408, the user 402 can input the code into a field of a webpage executing on one or more servers communicatively coupled to the internet. In other examples, the online verification system 408 can execute locally on a computer of the user and communicate information to the healthcare practitioner 410. The online verification system 408 can receive the code as input by the user 402 and determine whether the code is indicative of a result of the test by comparing the code to a list of codes that are defined as indicative of results of a test. If the code is not indicative of a result, the call-center verification system 406 can respond that the code is invalid. If the code is indicative of a result, the call-center verification system 406 can let the user 402 know the results of the test and send an indication of the results of the test to a healthcare practitioner 410.

Next, either call-center verification system 406 or online verification system 408 (verification system 405) can obtain additional information from the user 402 with one or more automated protocol driven queries. The verification system 405 can obtain information regarding symptoms of a patient from the user 402 based on the results for the test. For example, when the results of the test indicate that the patient tested positive for strep throat, the verification system 405 can ask questions to determine the extent of the infection. Likewise, when the results of the test indicate that the patient tested negative for strep throat, the verification system 405 can ask questions to determine if the patient has something with similar symptoms. In an example, when the question answers or test results is above preset limits, the user 402 can be notified to visit a healthcare practitioner in person.

The verification system 405 can send information regarding the result of the test to a third party, for example, healthcare practitioner 410. Since the results of the test are verified independent of the user 402, the healthcare practitioner 410 can rely on the results and diagnose the patient based on the results. The verification system 405 can create a record for review by the healthcare practitioner 410. The healthcare practitioner 410 can also be send the information from the automated questions asked to the user 402 in order to further ascertain the symptoms of the user 402. The healthcare practitioner 402 can then send information indicative of a diagnosis to the practitioner, via, for example, the verification system 410. The diagnosis can be real-time with the healthcare practitioner 410 analyzing the results and question answers as soon as they are received, or the diagnosis can be done at a time later than the input of the information by the user 402. In an example, the healthcare practitioner 410 can send prescription information to the retail center 404 for the user 402 to obtain. Accordingly, a verifiable, cost and time efficient mechanism can exist for diagnosis of a patient.

In an example, prior to sending information to the healthcare practitioner 410 or prior to providing results of the test or diagnosis to the user 402, the verification system 405 can obtain payment (e.g., via credit card) from the user 402. Additionally, the verification system 405 can provide user 402 with a recommendation via, for example, email including symptoms to watch, when to follow up, home care alternatives, etc.

In an alternative example, an electronic testing device can securely communicate results to the verification system 405 for sending to the third party 410. For example, the electronic testing device can obtain information indicative of the results of a test as discussed with respect to FIG. 3. The electronic testing device can then send the results to the verification system 405 via a network (e.g., the internet). In some examples, an intermediary device can be used to obtain the results from the electronic testing device and send the results to the verification system 405. In any case, the verification system 405 can verify the results are sent from an authorized device through, for example, software authentication. Thus, the verification system 405 can verify the results of the test independent of the user 405. To enable communication between the electronic testing device and the verification system 405, the user 402 may, for example, connect the electronic testing device (or a portion thereof) to a personal computer. The personal computer can then retrieve the information from the electronic testing device and send the information to the verification system 405.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

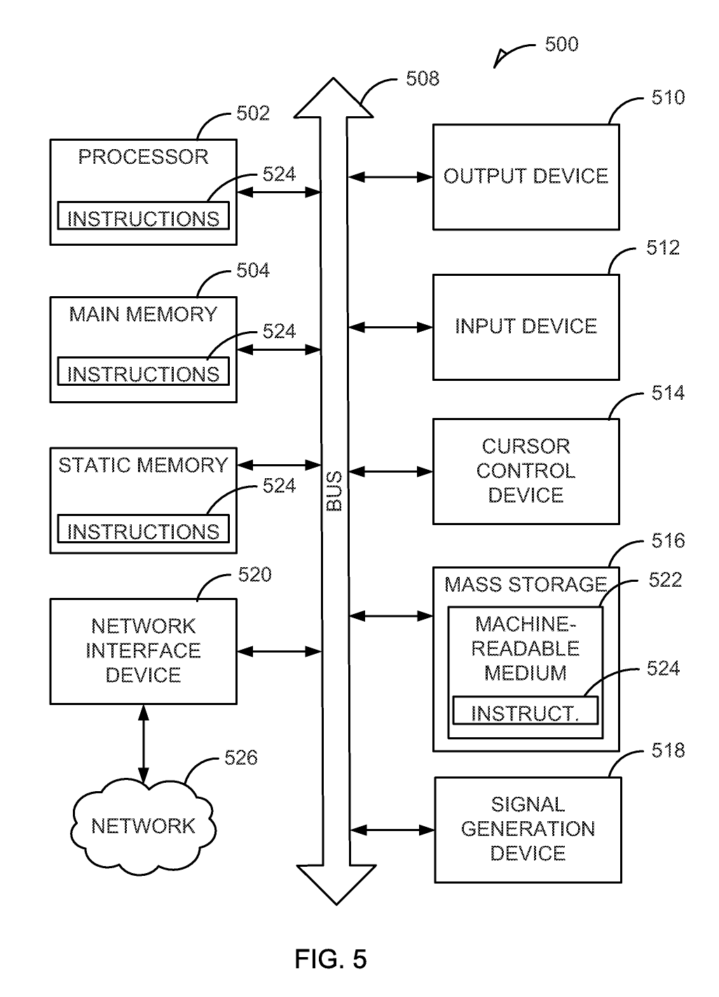

FIG. 5 illustrates generally an example of a computer 500 (machine). Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that can be employed to create one or more software programs designed to implement and perform the methods disclosed herein. The programs can be structured in an object-orientated format using an object-oriented language, such as Java, C++, or one or more other languages. Alternatively, the programs can be structured in a procedure-orientated format using a procedural language, such as assembly, C, etc. The software components can communicate using any of a number of mechanisms well known to those of ordinary skill in the art, such as application program interfaces or interprocess communication techniques, including remote procedure calls or others. The teachings of various embodiments are not limited to any particular programming language or environment.

Thus, other embodiments can be realized. For example, an article of manufacture, such as a computer, a memory system, a magnetic or optical disk, some other storage device, or any type of electronic device or system can include one or more processors 502 coupled to a machine-readable medium 522 such as a memory (e.g., removable storage media, as well as any memory including an electrical, optical, or electromagnetic conductor) having instructions 524 stored thereon (e.g., computer program instructions), which when executed by the one or more processors 502 result in performing any of the actions described with respect to the methods above.

The computer 500 can take the form of a computer system having a processor 502 coupled to a number of components directly, and/or using a bus 508. Such components can include main memory 504, static or non-volatile memory 506, and mass storage 516. Other components coupled to the processor 502 can include an output device 510, such as a video display, an input device 512, such as a keyboard, and a cursor control device 514, such as a mouse. A network interface device 520 to couple the processor 502 and other components to a network 526 can also be coupled to the bus 508. The instructions 524 can further be transmitted or received over the network 526 via the network interface device 520 utilizing any one of a number of well-known transfer protocols (e.g., HTTP). Any of these elements coupled to the bus 508 can be absent, present singly, or present in plural numbers, depending on the specific embodiment to be realized.

In an example, one or more of the processor 502, the memories 504, 506, or the storage device 516 can each include instructions 524 that, when executed, can cause the machine 500 to perform any one or more of the methods described herein. In alternative embodiments, the computer 500 operates as a standalone device or can be connected (e.g., networked) to other machines. In a networked environment, the machine 500 can operate in the capacity of a server or a client machine in server-client network environment, or as a peer machine in a peer-to-peer (or distributed) network environment. The computer 500 can include a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine 500 is illustrated, the term “machine” shall also be taken to include any collection of machines that individually or jointly execute a set (or multiple sets) of instructions to perform any one or more of the methodologies discussed herein.

While the machine-readable medium 524 is shown as a single medium, the term “machine-readable medium” should be taken to include a single medium or multiple media (e.g., a centralized or distributed database, or associated caches and servers, and or a variety of storage media, such as the processor 502 registers, memories 504, 506, and the storage device 516) that store the one or more sets of instructions 524. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to tangible media, such as solid-state memories, optical, and magnetic media.

### Example Embodiments

Example 1 includes a method for verifying a result of a test. The method includes providing a first plurality of codes, wherein each of the first plurality of codes are indicative of the same result of a test, wherein the same result comprises a first result of a test. The method also includes performing a first test on a material. A first code of the plurality of codes is output when the first test produces the first result.

In Example 2, the subject matter of Example 1 can optionally include defining the first plurality of codes as indicative of the first result of a test prior to performing the first test.

In Example 3, the subject matter of any one of Examples 1-2 can optionally include that when the first test produces a second result, no code is output.

In Example 4, the subject matter of any one of Examples 1-3 can optionally include providing a second plurality of codes that are indicative of a second result of a test, and outputting a second code of the second plurality of codes when the first test produces the second result.

In Example 5, the subject matter of any one of Examples 1-4 can optionally include performing a plurality of tests, and outputting a code of the first plurality of codes for each test of the plurality of tests that produces the first result.

In Example 6, the subject matter of any one of Examples 1-5 can optionally include wherein the first code is a unique code that is not used to indicate a result other than the first result of the first test.

In Example 7, the subject matter of any one of Examples 1-6 can optionally include when the number of tests performed is greater than the number of codes of the first plurality of codes, the first code of the plurality of codes is re-used to indicate a first result of a test other than the first test.

In Example 8, the subject matter of any one of Examples 1-7 can optionally include wherein the first plurality of codes includes at least 25 different codes.

In Example 9, the subject matter of any one of Examples 1-8 can optionally include wherein the first code includes at least two symbols.

In Example 10, the subject matter of any one of Examples 1-9 can optionally include determining whether a chemical of interest is present in the material.

In Example 11, the subject matter of any one of Examples 1-10 can optionally include determining an amount of a chemical present in the material, and wherein the first result corresponds to at least a first amount of chemical present in the material.

Example 12 includes an electronic testing device including a memory device having a first code of a first plurality of codes stored therein, wherein each of the first plurality of codes are indicative of the same result of a test, wherein the same result comprises a first result of a test. The electronic testing device also includes an electronic circuit communicatively coupled to the memory device and configured to determine a result of a first test on a material, and output the first code when the first test produces the first result.

In Example 13, the subject matter of Example 12 can optionally include the first plurality of codes defined as indicative of the first result of a test prior to performing the first test.

In Example 14, the subject matter of any one of Examples 12-13 can optionally include that when the first test produces a second result, no code is output.

In Example 15, the subject matter of any one of Examples 12-14 can optionally include the memory device having a second code of a second plurality of codes stored therein, wherein the second plurality of codes are indicative of a second result of a test. The electronic circuit is configured to output the second code when the first test produces the second result.

In Example 16, the subject matter of any one of Examples 12-15 can optionally include wherein the first code is a unique code that is not used to indicate a result other than the first result of the first test.

In Example 17, the subject matter of any one of Examples 12-16 can optionally include wherein the first plurality of codes includes at least 25 different codes.

In Example 18, the subject matter of any one of Examples 12-17 can optionally include wherein the first code includes at least two symbols.

In Example 19, the subject matter of any one of Examples 12-18 can optionally include wherein the first code is output via a display of the electronic testing device.

In Example 20, the subject matter of any one of Examples 12-19 can optionally include wherein the electronic circuit is configured to analyze a test strip to determine a result of an assay on the test strip.

Example 21 includes a diagnostic test strip. The diagnostic test strip includes a sample zone for application of a fluid. The diagnostic test strip also includes at least one test zone having reagents for performing an assay, wherein an assay result can be obtained. The diagnostic test strip also includes an invisible result code, wherein the result code is one of a plurality of codes, wherein each of the plurality of codes are indicative of the same result of a test, wherein the same result comprises a first result of a test, and wherein the result code is configured to change from invisible to visible when the assay produces the first result.

In Example 22, the subject matter of Example 21 can optionally include a serial number associated with the diagnostic test strip, wherein a combination of the result code and the serial number is indicative of the first result of the assay.

In Example 23, the subject matter of any one of Examples 21-22 can optionally include wherein the first plurality of codes is defined as indicative of the first result of the assay prior to performing the assay.

In Example 24, the subject matter of any one of Examples 21-23 can optionally include wherein the result code is configured to remain invisible when the assay produces a second result.

In Example 25, the subject matter of any one of Examples 21-24 can optionally include wherein the first code is a unique code that is not used to indicate a result other than the first result of the assay.

Example 26 includes a method for verifying a result of a test. The method includes providing a first plurality of codes, wherein each of the first plurality of codes are indicative of the same result of a test, wherein the same result comprises a first result of a test. The method includes receiving a first code output by a testing device and determining whether the first code is one of the first plurality of codes. The method includes sending to a third party an indication that a user performed a test that produces the first result when the first code is one of the first plurality of codes.

In Example 27, the subject matter of Example 26 can optionally include providing a first plurality of codes that are indicative of a first result of a test on a material. The method also determines whether the first code is one of the second plurality of codes. When the second code is one of the second plurality of codes an indication that the user performed a test that produces the second result is sent to the third party.

In Example 28, the subject matter of any one of Examples 27-27 can optionally include outputting that the code is invalid when the first code does not indicate a result of a test.

In Example 29, the subject matter of any one of Examples 26-28 can optionally include receiving a second plurality of codes from a plurality of users and determining whether any of the plurality of codes is one of the first plurality of codes. For each code of the second plurality of codes that is one of the first plurality of codes, sending to the third party an indication that a test performed by a user corresponding to the each code produced the first result.

In Example 30, the subject matter of any one of Examples 26-29 can optionally include wherein the first code is a composite code including serial number and a result code.

In Example 31, the subject matter of any one of Examples 26-30 can optionally include displaying the first result on a display for the user to view.

In Example 32, the subject matter of any one of Examples 26-31 can optionally include wherein each code of the first plurality of codes includes at least two symbols.

In Example 33, the subject matter of any one of Examples 26-32 can optionally include wherein the plurality of code include at least 25 different codes.

Example 34 includes a system for verifying a result of a test. The system includes one or more processors and at least one memory device, the at least one memory device having a first plurality of codes stored thereon, wherein the same result comprises a first result of a test, the at least one memory device including instruction that, when executed by the one or more processors, cause the one or more processors to receive a first code from a user, determine whether the first code is one of a plurality of codes, and send to a third party an indication that a user performed a test that produces the first result when the first code is one of the first plurality of codes.

In Example 35, the subject matter of Example 34 can optionally includes the instructions cause the one or more processors to determine whether the first code is one of the second plurality of codes and send to the third party an indication that the user performed a test that produces the second result when the second code is one of the second plurality of codes.

In Example 36, the subject matter of any one of Examples 34-35 can optionally include wherein the instructions cause the one or more processors to output that the code is invalid when the first code does not indicate a result of a test.

In Example 37, the subject matter of any one of Examples 34-36 can optionally include wherein the instructions cause the one or more processors to receive a second plurality of codes from a plurality of users, determine whether any of the plurality of codes is one of the first plurality of codes, and for each code of the second plurality of codes that is one of the first plurality of codes, send to the third party an indication that a test performed by a user corresponding to the each code produced the first result.

In Example 38, the subject matter of any one of Examples 34-37 can optionally include wherein the first code is a composite code including a serial number and a result code.

In Example 39, the subject matter of any one of Examples 34-38 can optionally include a display device, wherein the first result is displayed on the display device for a user to view.

In Example 40, the subject matter of any one of Examples 34-39 can optionally include wherein each code of the plurality of codes includes at least two symbols.

In Example 41, the subject matter of any one of Examples 34-40 can optionally include wherein the plurality of codes include at least 25 different codes.

Example 42 includes a machine-readable medium containing instructions that, when executed by one or more processors, cause the one or more processor to receive a first code from a user, determine whether the first code is one of a plurality of codes, wherein each of the first plurality of codes are indicative of the same result of a test, wherein the same result comprises a first result of a test. The method also includes sending to a third party an indication that a user performed a test that produced the first result when the first code is one of the first plurality of codes.

In Example 43, the subject matter of any one of Examples 42-43 can optionally include wherein the instructions cause the one or more processors to determine whether the first code is one of the second plurality of codes and send to the third party an indication that the user performed a test that produced the second result when the second code is one of the second plurality of codes.

In Example 44, the subject matter of any one of Examples 42-44 can optionally include wherein the instructions cause the one or more processors to output that the code is invalid when the first code does not indicate a result of a test.

In Example 45, the subject matter of any one of Examples 42-45 can optionally include wherein the instructions cause the one or more processors to receive a second plurality of codes from a plurality of users, determine whether each of the plurality of codes is one of the first plurality of codes, and for each code of the second plurality of codes that is one of the first plurality of codes, send to the third party an indication that a test performed by a user corresponding to the each code produced the first result.

Example 46 includes a method of diagnosing a patient online. The method includes receiving information regarding a result of an at-home medical test performed by a patient. The method also includes verifying the result of the at-home medical test based on a code output by a testing device. The method also includes providing information indicative of the result of the at-home medical test to a healthcare practitioner, the information provided based on the verification of the result of the at-home medical test. The method also includes receiving information indicative of a diagnosis for the patient from the healthcare practitioner. The method also includes providing the information indicative of a diagnosis to the patient.

In Example 47, the subject matter of Example 46 can optionally include initiating an e-visit comprising a plurality of questions regarding symptoms of the patient.

In Example 48, the subject matter of any one of Examples 46-47 can optionally include receiving information regarding symptoms of the patient, and sending information indicative of the symptoms of the patient to a healthcare practitioner.

In Example 49, the subject matter of any one of Examples 46-48 can optionally include wherein the e-visit comprises a series of automated questions.

In Example 50, the subject matter of any one of Examples 46-49 can optionally include receiving information regarding a prescription for the patient from the healthcare practitioner based on the result of the at-home medical test.

In Example 51, the subject matter of any one of Examples 46-50 can optionally include wherein the result of the at-home medical test is verified by comparing a code from the at-home medical test to a list of codes indicative of a result of the at-home medical test.

In Example 52, the subject matter of any one of Examples 46-51 can optionally include wherein the result of the at-home medical test is verified by determining that the result was sent by an authorized device.

Example 53 includes a system for online diagnosis of a patient. The system includes one or more processors and a memory including instruction that, when executed by the one or more processors, cause the one or more processors to receive information regarding a result of an at-home medical test performed by a patient, verify the result of the at-home medical test based on a code output by a testing device, provide information indicative of the result of the at-home medical test to a healthcare practitioner, the information provided based on the verification of the at-home medical test, receive information indicative of a diagnosis for the patient from the healthcare practitioner, and provide the information indicative of a diagnosis to the patient.

In Example 54, the subject matter of Example 53 can optionally include the instructions that cause the one or more processors to initiate an e-visit comprising a plurality of questions regarding symptoms of the patient.

In Example 55, the subject matter of any one of Examples 53-54 can optionally include instructions that cause the one or more processors to receive information regarding symptoms of the patient and send information indicative of the symptoms of the patient to a healthcare practitioner.

In Example 56, the subject matter of any one of Examples 53-55 can optionally include wherein the e-visit comprises a series of automated questions.

In Example 57, the subject matter of any one of Examples 53-56 can optionally include instructions that cause the one or more processors to receive information regarding a prescription for the patient from the healthcare practitioner based on the result of the at-home medical test.

In Example 58, the subject matter of any one of Examples 53-57 can optionally include wherein the result of the at-home medical test is verified by comparing a code from the at-home medical test to a list of codes indicative of a result of the at-home medical test.

In Example 59, the subject matter of any one of Examples 53-58 can optionally include wherein the result of the at-home medical test is verified by determining that the result was sent by an authorized device.

Example 60 includes a machine-readable medium containing instructions that, when executed by one or more processors, cause the one or more processor to receive information regarding a result of an at-home medical test performed by a patient, verify the result of the at-home medical test based on a code output by a testing device, provide information indicative of the result of the at-home medical test to a healthcare practitioner, the information provided based on the verification of the result of the at-home medical test, receive information indicative of a diagnosis for the patient from the healthcare practitioner, and provide the information indicative of a diagnosis to the patient.

In Example 61, the subject matter of Example 60 can optionally include the instructions that cause the one or more processors to initiate an e-visit comprising a plurality of questions regarding symptoms of the patient.

In Example 62, the subject matter of any one of Examples 60-61 can optionally include instructions that cause the one or more processors to receive information regarding symptoms of the patient and send information indicative of the symptoms of the patient to a healthcare practitioner.

In Example 63, the subject matter of any one of Examples 60-62 can optionally include instructions that cause the one or more processors to receive information regarding a prescription for the patient from the healthcare practitioner based on the result of the at-home medical test.

In Example 64, the subject matter of any one of Examples 60-63 can optionally include wherein the result of the at-home medical test is verified by comparing a code from the at-home medical test to a list of codes indicative of a result of the at-home medical test.

In Example 65, the subject matter of any one of Examples 60-64 can optionally include wherein the result of the at-home medical test is verified by determining that the result was sent by an authorized device.

These examples can be combined in any permutation or combination. This overview is intended to provide an overview of subject matter of the present patent application. It is not intended to provide an exclusive or exhaustive explanation of the invention. The detailed description is included to provide further information about the present patent application.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A method for verifying a result of a test, the method comprising:
providing a first plurality of codes, wherein each of the first plurality of codes are indicative of the same result of a test, wherein the same result comprises a first result of a test;
performing a first test on a material; and
outputting a first code of the first plurality of codes when the first test produces the first result.

2. The method of claim 1, comprising:
defining the first plurality of codes as indicative of the first result of a test prior to performing the first test.

3. The method of claim 1, wherein when the first test produces a second result, no code is output.

4. The method of claim 1, comprising:
providing a second plurality of codes that are indicative of a second result of a test; and
outputting a second code of the second plurality of codes when the first test produces the second result.

5. The method of claim 1, comprising:
performing a plurality of tests; and
outputting a code of the first plurality of codes for each test of the plurality of tests that produces the first result.

6. The method of claim 5, wherein the first code is a unique code that is not used to indicate a result other than the first result of the first test.

7. The method of claim 5, wherein when the number of tests performed is greater than the number of codes of the first plurality of codes, the first code of the plurality of codes is re-used to indicate a first result of a test other than the first test.

8. The method of claim 1, wherein the first plurality of codes includes at least 25 different codes.

9. The method of claim 1, wherein the first code includes at least two symbols.

10. The method of claim 1, wherein performing the test includes determining whether a chemical of interest is present in the material.

11. The method of claim 1, wherein performing the test includes determining an amount of a chemical present in the material; and
wherein the first result corresponds to at least a first amount of chemical present in the material.

12. A electronic testing device comprising:
a memory device having a first code of a first plurality of codes stored therein, wherein each of the first plurality of codes are indicative of the same result of a test, wherein the same result comprises a first result of a test;
an electronic circuit communicatively coupled to the memory device and configured to:
determine a result of a first test on a material; and
output the first code when the first test produces the first result.

13. The electronic testing device of claim 12, wherein the first plurality of codes are defined as indicative of the first result of a test prior to performing the first test.

14. The electronic testing device of claim 12, wherein when the first test produces a second result, no code is output.

15. The electronic testing device of claim 12, wherein the memory device has a second code of a second plurality of codes stored therein, wherein the second plurality of codes are indicative of a second result of a test;
wherein the electronic circuit is configured to:
output the second code when the first test produces the second result.

16. The electronic testing device of claim 12, wherein the first code is a unique code that is not used to indicate a result other than the first result of the first test.

17. The electronic testing device of claim 12, wherein the first plurality of codes include at least 25 different codes.

18. The electronic testing device of claim 12, wherein the first code includes at least two symbols.

19. The electronic testing device of claim 12, wherein the first code is output via a display of the electronic testing device.

20. The electronic testing device of claim 12, wherein the electronic circuit is configured to analyze a test strip to determine a result of an assay on the test strip.

21. A diagnostic test strip comprising:
a sample zone for application of a fluid;
a test zone having reagents for performing an assay, whereby an assay result can be obtained; and
an invisible result code, wherein the result code is one of a plurality of codes, wherein each of the plurality of codes are indicative of the same result of a test, wherein the same result comprises a first result of a test, and wherein the result code is configured to change from invisible to visible when the assay produces the first result.

22. The diagnostic test strip of claim 21, comprising:
a serial number associated with the diagnostic test strip, wherein a combination of the result code and the serial number is indicative of the first result of the assay.

23. The diagnostic test strip of claim 21, wherein the first plurality of codes is defined as indicative of the first result of the assay prior to performing the assay.

24. The diagnostic test strip of claim 21, wherein the result code is configured to remain invisible when the assay produces a second result.

25. The diagnostic test strip of claim 21, wherein the first code is a unique code that is not used to indicate a result other than the first result of the assay.
